(19) United States
(12) Patent Application Publication
(10) Pub. No.: US 2022/0283447 A1
(43) Pub. Date: Sep. 8, 2022

(54) REMOVABLE, INTERCHANGEABLE, UNBREAKABLE, SCREWLESS, ONE-PIECE FLEXIBLE SPRING HINGE SYSTEM FOR EYEWEAR

(71) Applicant: Joseph Tardif, Marietta, GA (US)

(72) Inventor: Joseph Tardif, Marietta, GA (US)

(21) Appl. No.: 17/684,472

(22) Filed: Mar. 2, 2022

Related U.S. Application Data
(60) Provisional application No. 63/155,402, filed on Mar. 2, 2021.

(51) Int. Cl. G02C 5/22

(52) U.S. Cl. CPC G02C 5/2209

(57) ABSTRACT

An eyewear hinge system for connecting an eyeglass chassis to a face securing means. The hinge system is an elastomeric component having a connection end to a chassis and a connection end to a temple or headband. In some embodiments, the chassis and temple connection ends are T-shaped protruding flanges and the chassis and temple have corresponding T-shaped cavities for removable receipt of same, respectively. In other embodiments, the band connection end has an opening to receive a band. The hinge may be curved at rest and have two V-shaped narrowings on an outer side of the hinge to allow greater folding capabilities when in use or not in use. A band hinge, a temple hinge, a chassis, a temple, and a band form a sports eyewear system having interchangeability features for different uses. A method of assembly using the disclosed eyewear hinge system.

### CROSS REFERENCE TO RELATED APPLICATIONS

To the full extent permitted by law, the present U.S. Non-Provisional Patent Application hereby claims priority to and the full benefit of, U.S. Provisional Application No. 63/155,402, filed Mar. 2, 2021, entitled “FLEXIBLE OPTICAL HINGE”, which is incorporated herein by reference in its entirety.

### FIELD OF THE DISCLOSURE

The present disclosure generally relates to eyewear, namely, spectacles, sunglasses, or goggles. More specifically, the present disclosure is directed to component parts thereof, namely a hinge, or replacement thereof in the case of goggles, which facilitates the removal and/or exchange of other component parts thereof.

The present disclosure is not limited to any particular brand, style, type, form factor, or materials as they relate to eyewear, except as described below.

### BACKGROUND

Eyewear consists of items and accessories worn over the eyes, for fashion or adornment, protection against the environment (including but not limited to weather, particulate matter, and sunlight), and to improve and/or enhance visual acuity. Eyewear, namely glasses or spectacles, sunglasses, and goggles, generally include a pair of eye wires or rims surrounding and holding the lenses in place and a bridge connecting the eye wires and/or rims, which together form the chassis of the eyewear. In the case of spectacles and sunglasses, eyewear can further include temples, which generally extend substantially perpendicularly from the chassis and generally rest on an ear portion of the step upon a wearer's ears during wear. In the case of goggles, the chassis may be connected to a strap or band for securing the chassis to the head of the wearer, over the eyes. Other component parts commonly or optionally found in eyewear such as spectacles, sunglasses, and goggles may include but are not limited to a top bar (to reinforce a bridge or provide the “aviator” aesthetic), brows or caps (for style enhancement and/or lens support), nose pads, pad arms for nose pad connections, temple tips, earpieces, hinges, various connection parts thereof (e.g., screws), bands, the like and/or combinations thereof. Generally, spectacles, sunglasses, and goggles may be manufactured from one or more of a variety of materials, including but not limited to cellulose acetate, optyl, cellulose propionate, nylon, other plastics, metals, and natural materials or materials derived thereof, such as rubber, wood, bone, ivory, leather, and/or semi-precious or precious stones.

In eyewear having temples, the temples may be hinged so that the eyewear may be folded twice: once at each connection between the chassis and each temple (i.e., the left and right sides of the chassis). Folding eyewear is often preferable to non-folding eyewear as it may offer the benefit of easier and more convenient storage during non-use. In recent years, innovation in the materials sciences and eyewear industry has allowed manufacturers to provide consumers with options that are more simple, stylish, lightweight, durable, and/or of materials desirable to consumers, especially in the sports eyewear segment. The simplest construction may offer a single molded or otherwise manufactured part having both a chassis and the left and right temples as a unified part with lenses that can be installed and/or exchanged. Such a design may not require a hinge or other parts (e.g., screws) which may be required for the installation of a hinge, but do not generally offer the ability to fold the eyewear during non-use. So, while numerous designs such as this may exist, a simple manufacture to not include hinges, screws, and the like and/or combinations thereof, may not offer the most suitable and convenient form factor for wearers desiring to conveniently store during non-use. Since sports eyewear may normally be used only during sporting activities, then potentially switched for non-sports eyewear, this type simplified design may be especially undesirable in sporting eyewear. As may be the case in goggles, hinges and screws may be unnecessary to achieve a connection to a strap, though the chassis of the goggles may be limited to situations where a goggle strap would be appropriate, and thereby a need for a second chassis or second eyewear for other settings, which a strap or goggles are not similarly appropriate for wear. Recognizing that individual wearers may prefer or desire to wear a consistent chassis in various circumstances, the capability for a chassis to interoperate with temples and a goggles strap may meet such preferences and desires. Additionally, recognizing that various parts may be required to secure a hinge to a chassis and a pair of temples, and that those parts may possess varying degrees of durability (e.g., plastic chassis and metal screws securing a metal hinge), the inclusion of a hinge in the manufacture of eyewear can pose inherent issues to the overall durability and function of an eyewear. For instance, a metal screw may be under or over torqued into its receiving socket in plastic eyewear, each causing issues to longevity of the eyewear. Additionally, welding or otherwise adhering the hinge to a chassis and/or a temple may present other tradeoffs as it relates to durability of the eyewear.

At present, there are various eyewear assemblies in the market having a hinge structure without screw(s), adhesive, or welding securing the hinge to the chassis and each temple. In various embodiments, the hinge structure may have a first portion connected to the chassis, and a second portion connected to the temple. The second portion and first portion may be designed such that the second portion can couple with the first portion, and thus it can rotate relative to the first portion. Additionally, other designs are available where a chassis is designed to directly receive either temple, and when operably combined, the chassis and temples may function as hinges of or hinged to each other. In other words, the temple(s) form a first hinge portion and the chassis form a second hinge portion and the eyewear may consist of only temples, and chassis with lenses. However, each of such hinge structures may possess some deficiencies. After using for various periods of time, depending on the underlying durability of the materials used in the component parts, the chassis connection to the temple(s) or the temple connection(s) to the chassis may deteriorate and/or crack and break, rendering the eyewear inoperable. Additionally, given that these hinge structures may require bending of component parts for securely “snapping” a temple into a chassis, forces acting upon an assembly may similarly bend and snap the hinge out of place, requiring the wearer to reassemble the eyewear, even if the component parts remain intact but separate. Finally, after a series of incidents where the chassis becomes uncoupled from the temple(s), after an unspecified number of hinge openings and closings, or after a period of normal wear-and-tear, the friction between the chassis and temple(s) may cause one or both operable connection mechanisms to wear or degrade, making decoupling more likely, and aggravating these problems.

Therefore, there is a need to provide an eyewear having a chassis capable of receiving a hinge, and/or a band connection, and in the case of spectacles and sunglasses, temples capable of receiving a hinge, each of which upon receipt of such hinge (or band connection) does not require a screw, welding, and/or adhesive. The chassis, the temples (or the band connection) and the hinge(s) connected thereto may then be operably combined to form the eyewear and even customized by the end user or “swapped” to provide a more versatile eyewear solution which is more durable than alternatives currently available in the market. As a whole, these component parts may serve as a removable, interchangeable, unbreakable, screwless, one-piece flexible spring hinge system for eyewear, which includes the ability to exchange one chassis style for another, the ability to exchange one or more temple style for another, and the ability to have both spectacle/sunglass and goggle form factors via a single chassis which can be connected to either of a temples pair or band connection pair and band/strap.

The instant disclosure may be designed to address at least certain aspects of the problems or needs discussed above by providing such a chassis and temples or chassis and band connection, each of which incorporate a specialized connection means (i.e., specialized hinge or band connection) capable of both secure connection to each of the chassis and temples/band via a locking or snapping assembly. Such a hinge may be comprised of an elastomeric material capable of bending to form in the eyewear an extended position and a folded position, or in the case of a goggle assembly, removal of the flexible hinge and insertion of a connector for the band. Each of the hinge and band connection may traverse through the chassis at an outermost portion (or proximate an outermost portion) of the chassis and removably snap into place. The hinge may further traverse through the temples, in the case of spectacles and sunglasses, to similarly secure and removably snap into place. Together, the chassis having a receptor for a specialized band connection or specialized hinge, the specialized hinge, the specialized band connection, and the temples having a comparable reception means may form a system for versatile screwless eyewear capable of folding and exchange between band connections, temple connections, the like and/or combinations thereof.

### SUMMARY

The present disclosure may solve the aforementioned limitations of the currently available eyewear systems by providing a removable, interchangeable, unbreakable, screwless, one-piece flexible spring hinge system for eyewear.

Accordingly, in one aspect, the present disclosure embraces the simplicity that may be achieved through the assembly of interchangeable eyewear component parts. This may be achieved via the manufacture of a chassis having a female connection side at or proximate each outer portion of said chassis. Such a chassis having a female connection side at or proximate each outer portion may be capable of receiving a male connection side of one or more components of the removable, interchangeable, unbreakable, screwless, one-piece flexible spring hinge system for eyewear. Another component of the removable, interchangeable, unbreakable, screwless, one-piece flexible spring hinge system for eyewear capable of being received by the chassis may include a hinge having a specialized male connection means to the chassis. Alternatively, or simultaneously, yet another component of the system may include a specialized band or band connection which is also or alternatively capable of being received by the female component (s)of the chassis. Temples may also be included, which are similarly capable of receiving the hinge which may further have a second male connection means to the temple(s) via a female connection side on the temple(s).

In an exemplary embodiment, the removable, interchangeable, unbreakable, screwless, one-piece flexible spring hinge system for eyewear includes at least one or more interchangeable chassis. The at least one or more interchangeable chassis may include connection means at or proximate to each chassis outer edge. The connection means may be female connection means or male connection means. The connection means may operably and/or interoperably engage with a securing connection means. The securing connection means may include hinge or band connection. Each of the securing connection means may further operably and/or interoperably connect with a securing means, such as a temple pair or a band/strap, respectively. The securing means may further include a connection to the securing connection means, which may also be a female connection means or a securing connection means. Generally, the hinge securing connection means may be flexible and comprised of an elastomeric material capable of bending.

In a potentially preferred exemplary embodiment, the chassis connects to the flexible hinge via a T-shaped protrusion from the chassis connection side of the hinge, which slides into a T-shaped cavity on each side of the chassis. The temples may contain a similar or identical T-shaped cavity to receive the temple connection side of the hinge via a T-shaped protrusion on said temple connection side of the hinge. The hinge may have one or more narrowings in its construction along an outer edge to allow for increased bending such that the hinge is curved substantially inward at rest, closing the spectacles assembly, but can be easily laterally forced open, the vertical narrowings accommodating this lateral movement. When operably combined, the chassis, hinges, and temples form the removable, interchangeable, unbreakable, screwless, one-piece flexible spring hinge system for eyewear. By manufacturing and offering multiple compatable versions of each of the chassis, hinge, and temples (or other securing means such as a band), wearers may be provided with a customizable, versatile system for a removable, interchangeable, unbreakable, screwless, one-piece flexible spring hinge system for eyewear. As such, various temples may be obtained by wearers to combine with various hinges and various chassis to create unique, custom arrangements for various uses such as driving, exercise, competitive sporting, recreation, screen viewing, movie watching, spectating, the like and/or combinations thereof.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a left side view of an exemplary embodiment of the removable, interchangeable, unbreakable, screwless, one-piece flexible spring hinge system for eyewear as it may be installed in a spectacle pair;

FIG. 2A is a top plan view of an exemplary embodiment of the removable, interchangeable, unbreakable, screwless, one-piece flexible spring hinge system for eyewear;

FIG. 2B is a left side view of an exemplary embodiment of the removable, interchangeable, unbreakable, screwless, one-piece flexible spring hinge system for eyewear;

FIG. 3 is a top plan view of an exemplary embodiment of the removable, interchangeable, unbreakable, screwless, one-piece flexible spring hinge system for eyewear as it may be installed in a spectacle pair, showing a wearer-right temple open and a wearer-left temple closed;

FIG. 4 is a wearer-right closeup of an exemplary embodiment of the removable, interchangeable, unbreakable, screwless, one-piece flexible spring hinge system for eyewear as it may be installed in a spectacle pair, the spectacle pair in the closed position;

FIG. 5 is a wearer-right closeup of an exemplary embodiment of the removable, interchangeable, unbreakable, screwless, one-piece flexible spring hinge system for eyewear as it may be installed in a spectacle pair, the spectacle pair in the open position;

FIG. 6 is a wearer-right closeup of an exemplary embodiment of the removable, interchangeable, unbreakable, screwless, one-piece flexible spring hinge system for eyewear as it may be installed in an alternate spectacle pair, the alternate spectacle pair in the open position;

FIG. 7 is a top plan view of an alternate embodiment of the removable, interchangeable, unbreakable, screwless, one-piece flexible spring hinge system for eyewear as it may be installed in a goggle pair, the goggle pair having a headband;

FIG. 8 is a step diagram showing an exemplary method of assembly of the removable, interchangeable, unbreakable, screwless, one-piece flexible spring hinge system for eyewear;

FIG. 9 is a closeup view of the first sub-step in the first step of the method;

FIG. 10 is a closeup view of the second sub-step of the first step in the method;

FIG. 11 is a closeup view of the first sub-step of the second step in the method;

FIG. 12 is a closeup view of the second sub-step of the second step in the method; and

FIG. 13 is a final view of the method, upon completion of the assembly.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

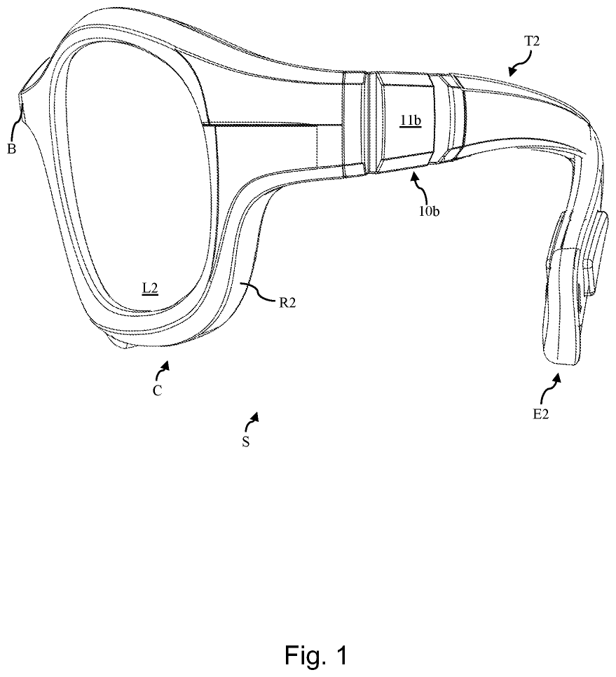

Referring now to FIGS. 1-13, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

The present disclosure solves the aforementioned limitations of the currently available devices and methods of eyewear assembly by providing a removable, interchangeable, unbreakable, screwless, one-piece flexible spring hinge system for eyewear.

Referring specifically to FIG. 1, therein illustrated is a left side view of an exemplary embodiment of the removable, interchangeable, unbreakable, screwless, one-piece flexible spring hinge system for eyewear as it may be installed in spectacles S. As may be understood by those having ordinary skill in the art, spectacles S as illustrated therein FIG. 1 may be of the sporting variety, though any form factor may be substituted according to systems and methods known to those having ordinary skill in the art. Additionally, the left portion of spectacles S, which is illustrated herein FIG. 1, may entail chassis C having bridge B and left rim R2 which houses left lens L2 and left temple T2 with left earpiece E2. Therebetween chassis C and left temple T2 may be installed left hinge 10b having left outward side 11b. The sizes, shapes, consistency, materials, features, and benefits of the removable, interchangeable, unbreakable, screwless, one-piece flexible spring hinge system for eyewear, when so configured according to the systems and methods disclosed herein, shall be more readily apparent to those having ordinary skill in the art after a thorough review of the remaining drawings and related description. As may be understood by those having skill in the art, full assemblies of the removable, interchangeable, unbreakable, screwless, one-piece flexible spring hinge system for eyewear may include or be recognized as spectacles, a goggles, a face-shield, a sports eyewear, a PPE eyewear, a tinted eyewear, a screen-viewing eyewear, a fashion eyewear, a sunglasses, a reading glasses, a corrective lens glasses, the like, and/or combinations thereof

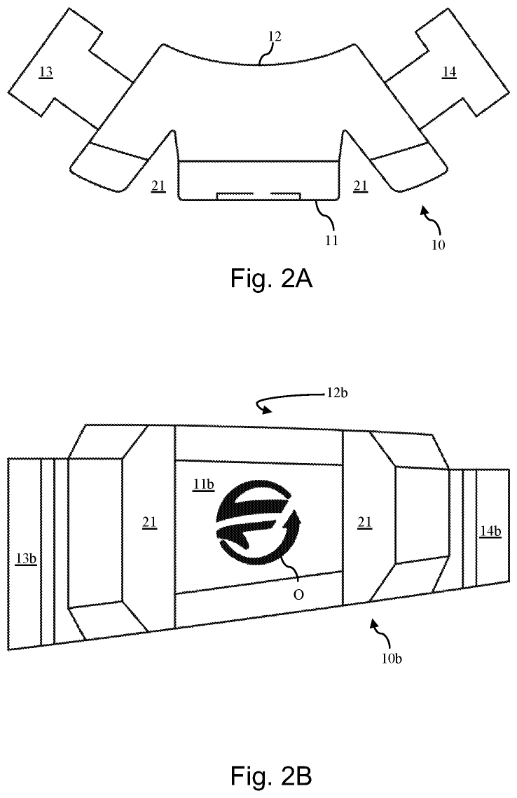

Turning now to FIG. 2A, therein illustrated is a top plan view of an exemplary embodiment of the removable, interchangeable, unbreakable, screwless, one-piece flexible spring hinge system for eyewear. Hinge 10 having hinge inward side 12 and hinge outward side 11 may be curved substantially inwardly toward hinge inward side 12. Two slits or vertical decreases in materials used for construction of hinge 10 along hinge outward side 11 may each form V-shaped narrowing 21. A T-shaped protrusion on each side of hinge 10 may form connections to temple T and chassis C, which are temple flange 14 and chassis flange 13. As may be appreciated by those having ordinary skill in the art, temple flange 14 and chassis flange 13 are drawn therein FIG. 2A such that each are identically sized and shaped, the T formed from an extension from hinge 10, such that a narrow portion of each of temple flange 14 and chassis flange 13 connects to the wider features of hinge 10 proximate each end of hinge 10, then protrude some at this uniform narrow width and suddenly protrude again to form the top cross portion of the T-shape. As will further be appreciated by those having ordinary skill in the art, temple flange 14 and chassis flange 13 may not require identical shape, size, or other features so long as cavity formations designed to receive and operably combine with each of temple flange 14 and chassis flange 13 on temple T and chassis C, respectively, are similarly differentiated. While a T-shaped structure is herein disclosed, other shapes for temple flange 14 and chassis flange 13 may provide similar utility and are encompassed by the disclosure herein. These may include, but are not limited to, pin connections, variously shaped prismatic connections, variously shaped dovetail joint/connections, a ball-and-socket joint arrangement, male/female socketed threading, cotterpin, universal joint connection, connections having pin-releases and/or snaps, the like and/or combinations thereof. As it relates to the functionality of the removable, interchangeable, unbreakable, screwless, one-piece flexible spring hinge system for eyewear, the inwardly curved structure of hinge 10 combined with one or more V-shaped narrowing(s) 21 and secure (but removable) combination with temple T and chassis C may offer great benefits to wearers, given a suitable material for manufacture of hinge 10. In a potentially preferred embodiment, hinge 10 may be constructed of a single, uniform material which comprises a one-part design for hinge 10. While many materials are known to exist which can achieve the properties necessary for the functionality of hinge 10, and are intended to be included as a feature of the instant disclosure, materials may be chosen for their excellent structural fatigue resistance, non-conductivity, tear and abrasion resistance, resistance to extreme temperatures, high impact strength, color-ability or tint-ability (if coloring is desired), low specific gravity, recyclability, resistance to chemicals and environmental factors (such as UV radiation and acid rain), and low compression set. The material or materials used may be selected from those which also offer the ability to bend when a force is applied, but which return to their original form once force is removed. Ideal or potentially preferred embodiments of hinge 10, and the materials thereof, may include but are not limited to thermoplastic elastomers comprising polypropylene, a copolymer of ethylene, propylene, ethylene-propylene rubber, the like and/or combinations thereof. Hundreds, if not thousands, of variations of thermoplastic elastomers and thermoplastic polymers may exist to fill such a need and are intended to be encompassed by the disclosure. For avoidance of doubt, while other materials are known to accomplish the intended benefits of the disclosed removable, interchangeable, unbreakable, screwless, one-piece flexible spring hinge system for eyewear, polyolefin thermoplastic elastomer materials, which are compounds or mixtures of various polyolefin polymers, semicrystalline thermoplastics, and amorphous elastomers may be used in the construction of hinge 10, such that in combination with the other various features described herein, function to hinge chassis C and temple T when operably combined.

Turning specifically to FIG. 2B, therein illustrated is a left side view of an exemplary embodiment left hinge 10b of the removable, interchangeable, unbreakable, screwless, one-piece flexible spring hinge system for eyewear. A person having ordinary skill in the art of spectacle manufacture would understand that a left side view is chiral to a right-side view, obviating the need to illustrate a right and left side. Those features illustrated herein of left hinge 10b are simply mirror images of features contained in right hinge 10a. As illustrated, left hinge 10b has left hinge outward side 11b, left hinge inward side 12b (behind), left chassis flange 13b, left temple flange 14b, and two V-shaped narrowings 21. As will be appreciated by those having ordinary skill in the art, left hinge 10b is not of uniform height, as illustrated. While alternate embodiments of the removable, interchangeable, unbreakable, screwless, one-piece flexible spring hinge system for eyewear may exist where hinge 10 does not have such a tapered, but rather a uniform, height, those having ordinary skill in the art should understand that a connection area to chassis C may be smaller or larger to that of the connection area for temple T and hinge 10 and its corresponding heights at each end may be similarly adjusted to accommodate height disparities between chassis C and temple T. For instance, in this particular design, the connection area of chassis C may be slightly larger than the connection area for temple T, thus the tapered height of hinge 10 widening as the hinge connects the two. The alternative could just as easily be true and each height may be identical, thus requiring a uniform height of hinge 10. All combinations are intended to be features and benefits of the disclosure herein. Finally, though not necessarily important to the overall function of hinge 10, it may be important to those having ordinary skill in the art that upon left hinge outward side 11b may exist ornamentation O (and similarly upon right hinge outward side 11a). As may be particularly important in the sporting market, this ornamentation may be easily customized or designed to include sporting teams, custom logos, initials, insignias, the like and/or combinations thereof to offer a unique customization and marketing opportunity to manufacturers of the removable, interchangeable, unbreakable, screwless, one-piece flexible spring hinge system for eyewear.

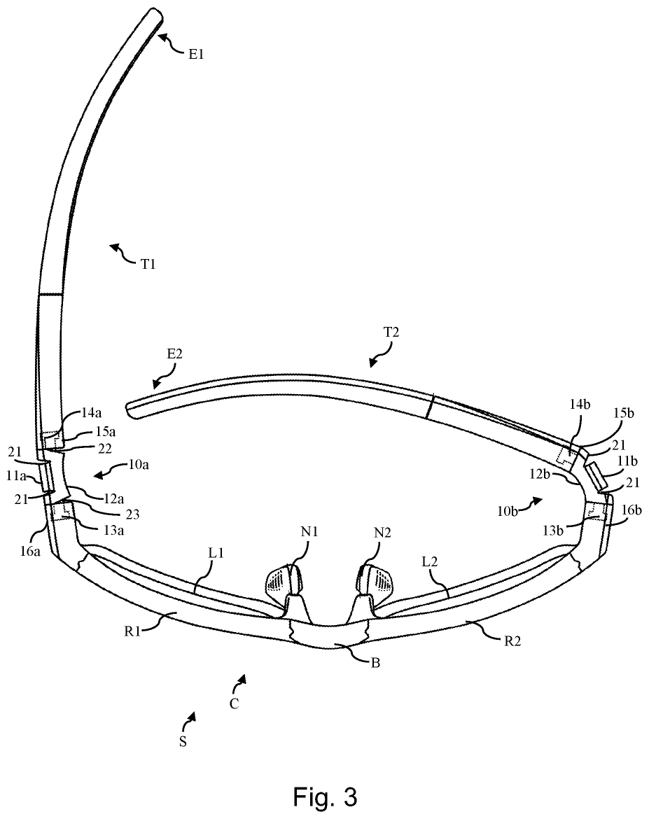

Turning now to FIG. 3, therein illustrated is a top plan view of an exemplary embodiment of the removable, interchangeable, unbreakable, screwless, one-piece flexible spring hinge system for eyewear as it may be installed in a spectacles S, showing a wearer-right temple (hereinafter right temple T1) open and a wearer-left temple (hereinafter left temple T2) closed. As may be obvious to those having skill in the art of spectacle manufacture, right temple T1 and left temple T2 are chiral and shown as open and closed to exploit this fact for efficiency sake. At rest both of right temple T1 and left temple T2 may be in an inwardly curved position making spectacles S closed for storage. Both may be opened or straightened during wear. Generally, spectacles S may include the component parts of chassis C, right hinge 10a, left hinge 10b, right temple T1, and left temple T2. Chassis C may generally comprise right rim R1 with right lens L1 installed therein and left rim R2 with left lens L2 installed therein. Bridge B may connect right rim R1 and left rim R2, though the chassis may be constructed of a single part or component having these identifiable areas. Right nosepiece N1 and left nosepiece N2 may reside at each side of bridge B to provide increased stability and comfort to the wearer. The chiral temples of right temple T1 and left temple T2 may include right earpiece E1 and left earpiece E2 to offer similar benefits to the wearer. Turning now to the connections among chassis C, right temple T1, and left temple T2, chassis C is connected to right temple T1 and left temple T2 via right hinge 10a and left hinge 10b, respectively. As described and illustrated in greater detail above, hinge 10 may have hinge inward side 12 and hinge outward side 11, and hinge 10 may be curved substantially inwardly toward hinge inward side 12. As illustrated herein, this remains true for each of right hinge 10a, left hinge 10b, right hinge inward side 12a, left hinge inward side 12b, right hinge outward side 11a, and left hinge outward side 11b. Two slits or vertical decreases in materials used for construction of hinge 10 along hinge outward side 11 may each form V-shaped narrowing 21. As illustrated herein FIG. 3, this V-shaped narrowing 21 is large when spectacles S is closed (left hinge 10b) and narrows substantially to accomplish the straightening required for wear as illustrated thereon right hinge 10a. As may also be noted, when opened or straightened, two fissures or gaps form on either side of right hinge 10a therebetween right temple T and right hinge 10a and right chassis C and right hinge 10a. These are temple/hinge fissure 22 and chassis/hinge fissure 23. The creation of temple/hinge fissure 22 and chassis/hinge fissure 23 during wear may be important to accomplishing the bending required to hinge temple T to chassis C. Each of temple/hinge fissure 22 and chassis/hinge fissure 23 may be accomplished using the materials described with relation to FIG. 2A as these materials may bend and flex but return to their previous form upon the removal of force. A T-shaped protrusion on each side of right and left hinges 10a-b may form connections to temples T1 and T2 and chassis C, which are temple flange 14 and chassis flange 13, illustrated as right temple flange 14a, left temple flange 14b, right chassis flange 13a, and left chassis flange 13b. In order to receive each of right temple flange 14a, left temple flange 14b, right chassis flange 13a, and left chassis flange 13b, in this potentially preferred embodiment, each of right temple T1, left temple T2 and each outer edge of chassis C may be manufactured having T-shaped cavities. Right temple T1 receives right temple flange 14a of right hinge 10a within right temple cavity 15a and left temple T2 receives left temple flange 14b of left hinge 10b within left temple cavity 15b. Similarly, chassis C receives right chassis flange 13a of right hinge 10a at right chassis cavity 16a and left chassis flange 13b of left hinge 10b at left chassis cavity 16b. As illustrated from above, if chassis C, right temple T1, and left temple T2 are constructed of opaque materials, the respective flanges and cavities may not be visible when viewed from above and are therefore drawn as dashed lines. As may be the case in this preferred embodiment, each of chassis C, right temple T1, and left temple T2 may be assembled using right hinge 10a and left hinge 10b by pressing the flanges into the cavities from beneath spectacles S. In such a case, each flange and cavity may be constructed with a height smaller than that of each intended connection to ensure the flange/cavity connection does not push through when connected. As may be understood by those having ordinary skill in the art, chassis C, right temple T1, and left temple T2 may be made of any number or combination of materials known to those having skill in the art of spectacle manufacture including but not limited to cellulose acetate, optyl, cellulose propionate, nylon, other plastics, metals, and natural materials or materials derived thereof, such as rubber, wood, bone, ivory, leather, and/or semi-precious or precious stones.

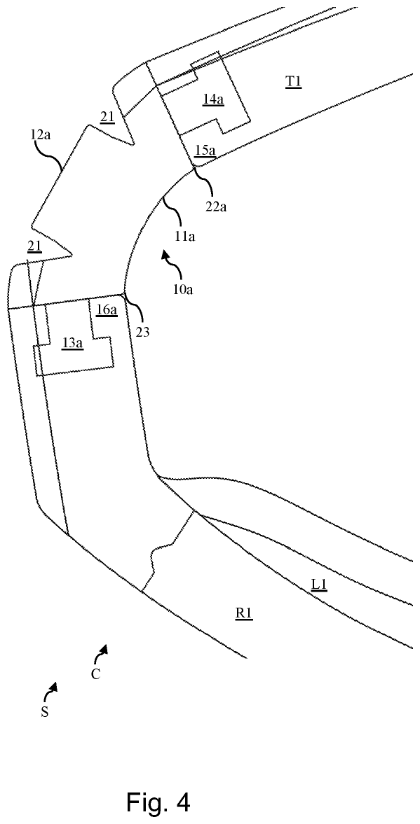

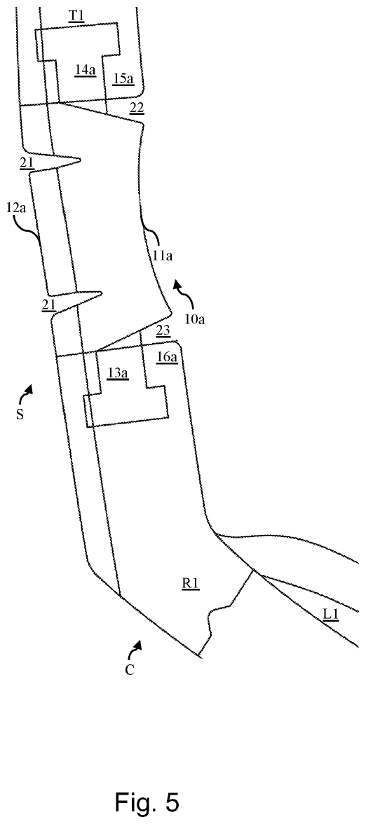

Turning to FIG. 4, therein illustrated is a wearer-right closeup of an exemplary embodiment of the removable, interchangeable, unbreakable, screwless, one-piece flexible spring hinge system for eyewear as it may be installed in spectacles S. As previously discussed, since the human face is generally symmetrical, the parts within spectacles S are normally chiral, meaning those features applicable to parts or features on the right side may apply to the left also. As illustrated therein FIG. 4, spectacles S is in the closed position. Chassis C (illustrated with right rim R1, right lens L1) is joined to right temple T1 via right hinge 10a, as illustrated. Right hinge 10a having right hinge inward side 12a and right hinge outward side 11a may be curved substantially inwardly at rest toward right hinge inward side 12a. Two slits or vertical decreases in materials used for construction of right hinge 10a along right hinge outward side 11a may each form V-shaped narrowing 21. A T-shaped protrusion on each side of right hinge 10a may form connections to right temple T1 and chassis C, which are right temple flange 14a and right chassis flange 13a. Proximate right hinge inward side 12a may exist temple/hinge fissure 22 and chassis/hinge fissure 23 at the inward side of the connection to right temple T1 and chassis C. As FIG.4 is illustrated in a closed position, both of temple/hinge fissure 22 and chassis/hinge fissure 23 may be minimal or non-existent in size. A review of FIG. 3 as well as the description related to the open position illustrated in FIG. 5 will further illuminate to those having ordinary skill in the art the importance of temple/hinge fissure 22 and chassis/hinge fissure 23 with regard to the mechanisms there involved. A potentially preferred connection between chassis C and right hinge 10a may include the operable removable combination that is achieved when sliding right chassis flange 13a into right chassis cavity 16a. A potentially preferred connection between right temple T1 and right hinge 10a may include the operable removable combination that is achieved when sliding right temple flange 14a into right temple cavity 15a.

Turning now to FIG. 5, therein illustrated is a wearer-right closeup of an exemplary embodiment of the removable, interchangeable, unbreakable, screwless, one-piece flexible spring hinge system for eyewear as it may be installed in spectacles S. As previously discussed, since the human face is generally symmetrical, the parts within spectacles S are normally chiral, meaning those features applicable to parts or features on the right side may apply to the left also. As illustrated therein FIG. 5, spectacles S is in the open position. Chassis C (illustrated with right rim R1, right lens L1) is joined to right temple T1 via right hinge 10a, as illustrated. Right hinge 10 having right hinge inward side 12a and right hinge outward side 11a may be curved substantially inwardly at rest toward right hinge inward side 12a, though it is not in the case of FIG. 5 because spectacles S are in the open position. Several mechanisms allow for the bending of right hinge 10a to achieve the open position of spectacles S. First, and most importantly, may be the materials used for the construction of right hinge 10a, as described with relation to FIG. 2A. Additionally, when the connection between chassis C and right hinge 10a via sliding right chassis flange 13a into right chassis cavity 16a and the connection between right temple T1 and right hinge 10a via sliding right temple flange 14a into right temple cavity 15a is formed, the innate curvature and flexibility of right hinge 10 combined with fissures formed at temple/hinge fissure 22 and chassis/hinge fissure 23 and the V-shaped narrowing(s) 21 on right hinge outward side 11a allow for easy flexibility to a point where wearers heads may typically fit, thereby potentially offering a superior grip on the wearer's head during wear. A comparison of FIGS. 4-5 may be useful to those having ordinary skill in the art in order to observe the changes in size with respect to V-shaped narrowing(s) 21, temple/hinge fissure 22, and chassis/hinge fissure 23

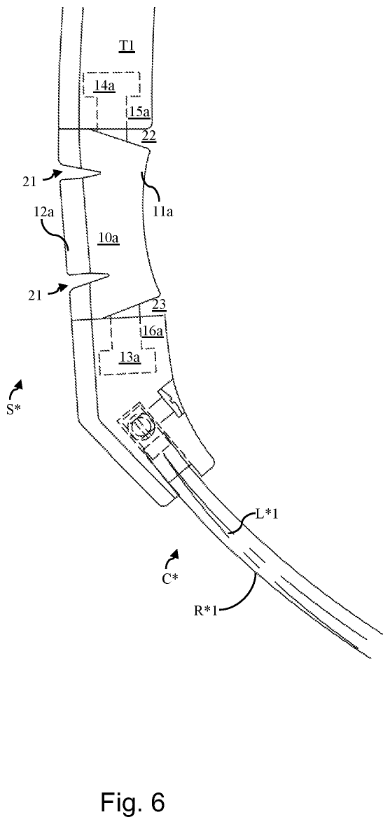

Turning now to FIG. 6, therein illustrated is a wearer-right closeup of an exemplary embodiment of the removable, interchangeable, unbreakable, screwless, one-piece flexible spring hinge system for eyewear as it may be installed in a different assembly of spectacles S, namely alternate spectacles S* having alternate chassis C*, alternate right lens L*1, and alternate right rim R*1. Alternate spectacles S* is illustrated in the open position. As may be appreciated by those having ordinary skill in the art, both chassis C and temple T, and any suitable component parts thereof, may be constructed with chassis cavity 16 and temple cavity 15, respectively, so as to operably combine with hinge 10. This enables manufacturers and users of the disclosed removable, interchangeable, unbreakable, screwless, one-piece flexible spring hinge system for eyewear to swap various colors, styles, types, etc. of temple T and chassis C to achieve a near-infinite number of possible combinations of spectacles S, depending on the nature of the use and desires of the manufacturers and/or wearers. Additional potential configurations are envisioned and intended to be included in the disclosure herein. Specifically, other embodiments which do not require temple T, such as goggles G, are disclosed below.

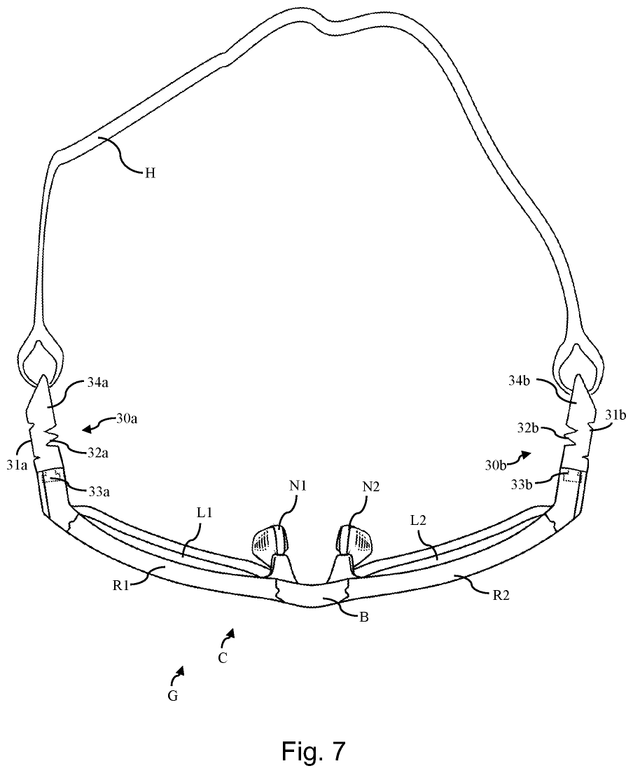

Turning now to FIG. 7, therein illustrated is a top plan view of an alternate embodiment of the removable, interchangeable, unbreakable, screwless, one-piece flexible spring hinge system for eyewear as it may be installed in goggles G. Goggles G is illustrated having headband H. In the disclosed removable, interchangeable, unbreakable, screwless, one-piece flexible spring hinge system for eyewear, chassis C may be utilized to form goggles G, or other designs may be used. Chassis C may generally comprise right rim R1 with right lens L1 installed therein and left rim R2 with left lens L2 installed therein. Bridge B may connect right rim R1 and left rim R2, though the chassis may be constructed of a single part or component having these identifiable areas. Right nosepiece N1 and left nosepiece N2 may reside at each side of bridge B to provide increased stability and comfort to the wearer. To form goggles G, temple T is replaced with headband H. Connecting chassis C with headband H may be right chassis/band connector 30a and left chassis/band connector 30b. Right chassis/band connector 30a may comprise generally right outward connector side 31a, right inward connector side 32a, right connector band opening 34a, and right connector flange 33a. Similarly, due to the chiral nature of chassis C and goggles G, left chassis/band connector 30b may comprise generally left outward connector side 31b, left inward connector side 32b, left connector band opening 34b, and left connector flange 33b. Operable removable combination of right connector flange 33a with right chassis cavity 16a and left connector flange 33b with left chassis cavity 16b along with the threading of headband H through right connector band opening 34a and left connector band opening 34b may form the general assembly of goggles G. In this embodiment, each of right outward connector side 31a, right inward connector side 32a, left outward connector side 31b, and left inward connector side 32b may have features similar to V-shaped narrowing(s) 21 of hinge 10 such that bending laterally is easily achieved by the wearer, but vertical bending is more difficult. It should be noted that in the removable, interchangeable, unbreakable, screwless, one-piece flexible spring hinge system for eyewear, the chassis-side flanges of hinge 10 may be analogous to that of right connector flange 33a and left connector flange 33b. In fact, in a potentially preferred embodiment of removable, interchangeable, unbreakable, screwless, one-piece flexible spring hinge system for eyewear, these components may be identically formed to achieve such a system which allows various combinations of bands, temples, chassis, etc.

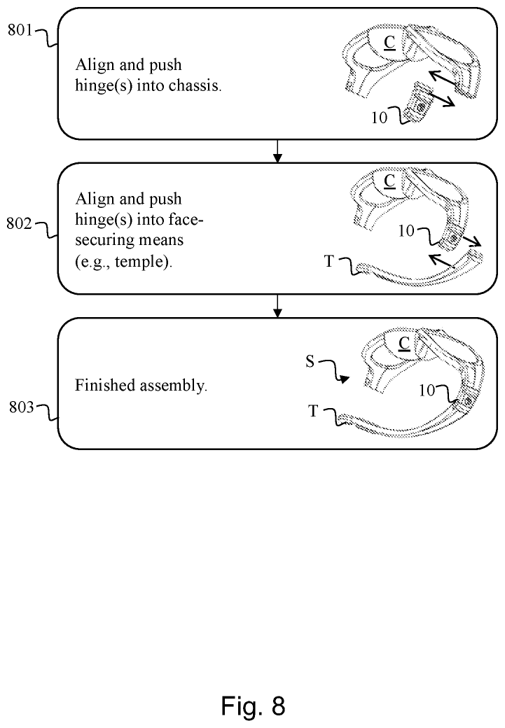

Turning now to FIG. 8, therein illustrated is a high-level illustrated step diagram (or annotated drawing) showing an exemplary method of assembly of the removable, interchangeable, unbreakable, screwless, one-piece flexible spring hinge system for eyewear. It should be noted at the outset that much like the removable, interchangeable, unbreakable, screwless, one-piece flexible spring hinge system for eyewear, the steps of the described method are not rigid, but are flexible to include variations and rearrangements in steps, which may ultimately arrive at the same completed assembly. Ordered steps are provided herein as examples and are not necessarily prescribed to occur in order. Beginning at first method step 801, which may include the sub-steps of first sub-step of first method step 801a and second sub-step of first method step 801b, hinge 10 is aligned with chassis C and pushed into chassis C. At second method step 802, which may include first sub-step of second method step 802a and second sub-step of second method step 802b, temple T and hinge 10 are similarly aligned and pushed into place. Final method step 803 completes the assembly, though steps 801-803 may be repeated to achieve a full assembly on left and right sides.

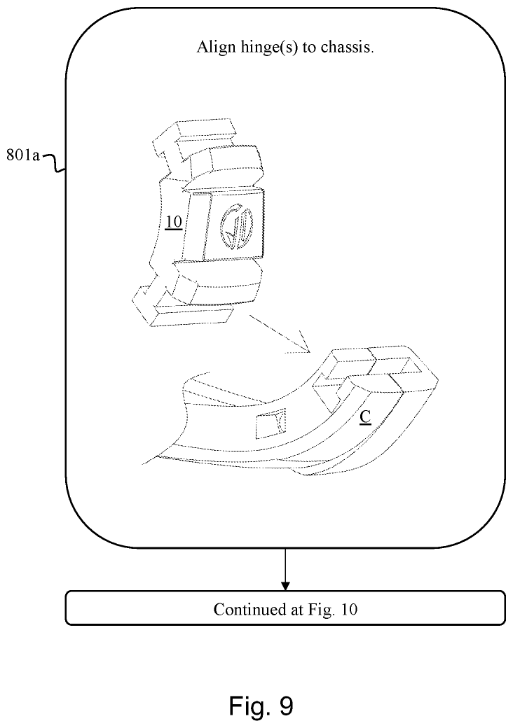

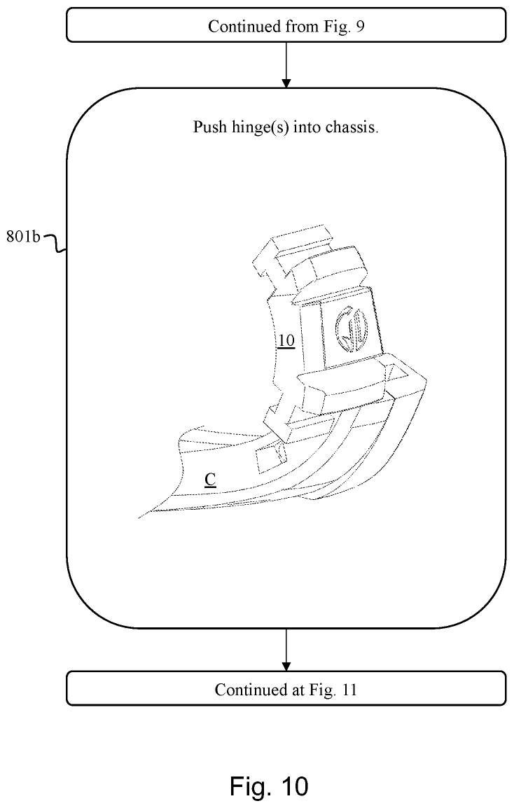

Turning now to FIG. 9, therein illustrated is a closeup view of first sub-step of first method step 801a of the disclosed method described generally in FIG. 8. First sub-step of first method step 801a generally requires hinge 10 be brought together with chassis C as illustrated therein FIG. 9, such that chassis flange 13 is aligned with chassis cavity 16. The disclosed method of the removable, interchangeable, unbreakable, screwless, one-piece flexible spring hinge system for eyewear continues at FIG. 10.

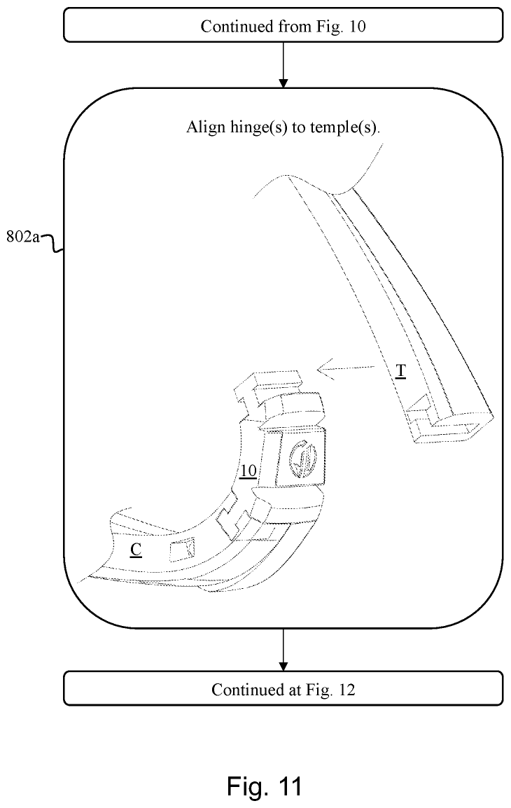

Turning now to FIG. 10, therein illustrated is a closeup view of second sub-step of first method step 801b of the disclosed method described generally in FIG. 8. Second sub-step of first method step 801b generally requires the components of hinge 10 and chassis C aligned in first sub-step of first method step 801b to be pushed together such that chassis flange 13 is fully within chassis cavity 16. The disclosed method of the removable, interchangeable, unbreakable, screwless, one-piece flexible spring hinge system for eyewear continues at FIG. 11.

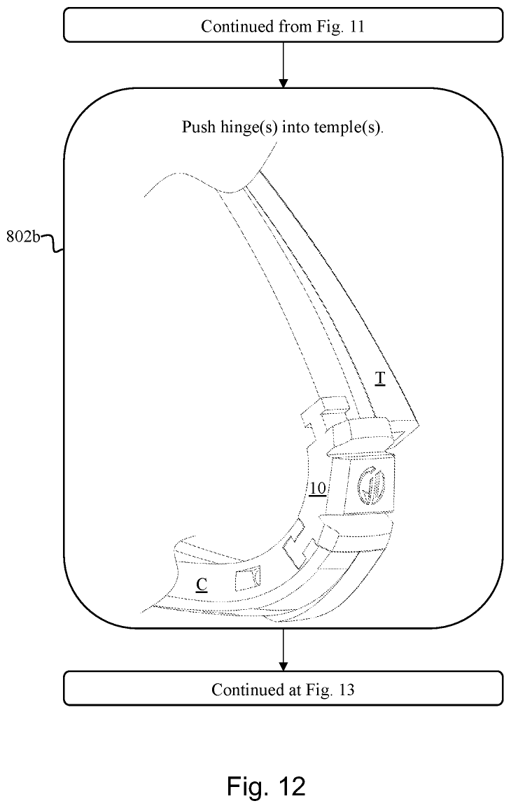

Turning now to FIG. 11, therein illustrated is a closeup view of first sub-step of second method step 802a of the disclosed method described generally in FIG. 8. Having aligned and assembled hinge 10 to chassis C in first method step 801 (see FIGS. 8-10), temple T is obtained and aligned with the present sub-assembly of chassis C and hinge 10. By aligning the substructures of temple flange 14 with temple cavity 15, further assembly may be performed. The disclosed method of the removable, interchangeable, unbreakable, screwless, one-piece flexible spring hinge system for eyewear continues at FIG. 12.

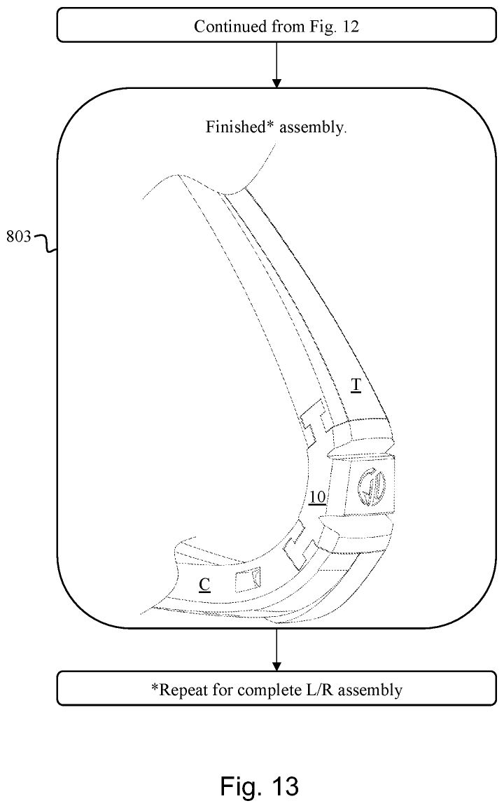

Turning now to FIG. 12, therein illustrated is a closeup view of second sub-step of second method step 802a of the disclosed method described generally in FIG. 8. Having an assembly which includes hinge 10 and chassis C, which was aligned with temple T at second sub-step of second method step 802, temple T can be pushed toward hinge 10 such that temple flange 14 fills the available space within temple cavity 15. The disclosed method of the removable, interchangeable, unbreakable, screwless, one-piece flexible spring hinge system for eyewear continues at FIG. 13.

Turning now to FIG. 13, therein illustrated is a closeup view of final method step 803 of the disclosed method described generally in FIG. 8. At steps 801-802, and the various sub-steps described herein, chassis C is combined with temple T via hinge 10 to complete an assembly of spectacles S. As should be recognized and understood by those having ordinary skill in the art, many combinations of temple T, chassis C, and hinge 10 may be possible to achieve a versatile, customizable, removable, interchangeable, unbreakable, screwless, one-piece flexible spring hinge system for eyewear.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A screwless hinge system for an eyewear, the system comprising:
an at least one elastomeric hinge having at least:
a chassis end;
a temple end;
an inward side; and
an outward side;
wherein said at least one elastomeric hinge is laterally curved toward said inward side therebetween said chassis end and said temple end, having a substantially uniform thickness therein except for a first V-shaped narrowing and a second V-shaped narrowing on said outward side;
an at least one chassis securing element configured to receive said at least one elastomeric hinge at said chassis end; and
an at least one temple securing element configured to receive said at least one elastomeric hinge at said temple end.

2. The screwless hinge system of claim 1, wherein said at least one temple securing element is an opening for receiving a band, the eyewear is a goggle.

3. The screwless hinge system of claim 2, wherein said substantially uniform thickness is further interrupted at said inward side by a third V-shaped narrowing and a forth V-shaped narrowing unopposed to said first V-shaped narrowing and said second V-shaped narrowing.

4. The screwless hinge system of claim 1, wherein said at least one chassis securing element is a T-shaped chassis cavity at a chassis end, a T-top portion of said T-shaped chassis cavity is substantially parallel with a chassis front and wherein said at least one temple securing element is a T-shaped temple cavity of a temple end, a T-top portion of said T-shaped temple cavity is substantially perpendicular to a temple length.

5. The screwless hinge system of claim 4, wherein said at least one chassis end of said at least one elastomeric hinge comprises a T-shaped chassis flange configured to removably couple with said T-shaped chassis cavity.

6. The screwless hinge system of claim 5, wherein said at least one temple end of said at least one elastomeric hinge comprises a T-shaped temple flange configured to removably couple with said T-shaped temple cavity.

7. The screwless hinge system of claim 6, wherein said at least one elastomeric hinge is a right elastomeric hinge and a left elastomeric hinge, said at least one chassis securing element is a right chassis securing element and a left chassis securing element, and said at least one temple securing element is a right temple securing element and a left temple securing element.

8. The screwless hinge system of claim 7, wherein the eyewear are spectacles.

9. The screwless hinge system of claim 6, wherein said at least one elastomeric hinge further comprises a chassis-end height and a temple-end height, said T-shaped chassis flange has a height smaller than said chassis-end height, said T-shaped temple flange has a height smaller than said temple-end height, said T-shaped chassis cavity has a height of said T-shaped chassis flange, and said T-shaped temple cavity has a height of said T-shaped temple cavity.

10. The screwless hinge system of claim 9, wherein said T-shaped temple cavity is an opening on a bottom of a temple and said T-shaped chassis cavity is an opening at a bottom of a chassis, said T-shaped temple cavity and said T-shaped chassis cavity do not have an opening at a top of said temple and a top of said chassis.

11. The screwless hinge system of claim 1, wherein the at least one elastomeric hinge is manufactured from an at least one thermoplastic elastomer from a group of thermoplastic elastomers, the group of thermoplastic elastomers consists of thermoplastic olefins, polyolefin polymers, semicrystalline thermoplastics, amorphous elastomers, polypropylene, ethylene, propylene, ethylene-propylene rubber, and mixtures, formulas, combinations, assemblies, compounds, co-formulations, and combinations thereof.

12. The screwless hinge system of claim 11, wherein the at least one thermoplastic elastomer has flexural fatigue resistance, lacks conductivity, is resistant to tear and abrasion, is resistant to extreme temperatures, possesses impact resistance, is colorable, is recyclable, has a low compression set, has a low specific gravity, and is resistant to UV and chemical deterioration.

13. A method of assembling an eyewear having a screwless hinge system, the method comprising:
providing an at least one elastomeric hinge having a chassis end, a temple end, an inward side and an outward side, the at least one elastomeric hinge is laterally curved toward said inward side therebetween said chassis end and said temple end, having a substantially uniform thickness except for a first V-shaped narrowing and a second V-shaped narrowing on said outward side;
providing an at least one chassis configured to receive said at least one elastomeric hinge at said chassis end;
providing an at least one temple configured to receive said at least one elastomeric hinge at said temple end;
forming a connection between said at least one elastomeric hinge said at least one chassis; and
forming a connection between said at least one elastomeric hinge and said at least one temple.

14. The method of claim 13, wherein said at least one chassis further comprises a T-shaped chassis cavity at a chassis end, a T-top portion of said T-shaped chassis cavity is substantially parallel with the chassis front.

15. The method of claim 14, wherein said at least one temple further comprises a T-shaped temple cavity of a temple end, a T-top portion of said T-shaped temple cavity is substantially perpendicular to a temple length.

16. The method of claim 15, wherein said at least one chassis end of said at least one elastomeric hinge comprises a T-shaped chassis flange configured to removably couple with said T-shaped chassis cavity.

17. The method of claim 16, wherein said at least one temple end of said at least one elastomeric hinge comprises a T-shaped temple flange configured to removably couple with said T-shaped temple cavity.

18. The method of claim 17, wherein said at least one elastomeric hinge is a right elastomeric hinge and a left elastomeric hinge, said at least one chassis and said at least one temple is a right temple and a left temple.

19. The method of claim 18, wherein the at least one elastomeric hinge is a left elastomeric hinge and a right elastomeric hinge.

20. The method of claim 13, wherein the eyewear is an eyewear type selected from a group of eyewear types, the group of eyewear types consists of a spectacles, a goggles, a face-shield, a sports eyewear, a PPE eyewear, a tinted eyewear, a screen-viewing eyewear, a fashion eyewear, a sunglasses, a reading glasses, and a corrective lens glasses.
